(19) United States
(12) Patent Application Publication
(10) Pub. No.: US 2014/0026972 A1
(43) Pub. Date: Jan. 30, 2014

(54) VALVE SYSTEM

(71) Applicants: Jason Stevens, Elmira (CA); Robert Nugteren, Bloomingdale (CA); Jack Bosman, Kitchener (CA); Andy Jenkins, London (CA)

(72) Inventors: Jason Stevens, Elmira (CA); Robert Nugteren, Bloomingdale (CA); Jack Bosman, Kitchener (CA); Andy Jenkins, London (CA)

(21) Appl. No.: 13/983,468

(22) PCT Filed: Feb. 3, 2012
(86) PCT No.: PCT/CA2012/000128

§ 371 Date: Oct. 9, 2013

Related U.S. Application Data
(60) Provisional application No. 61/439,716, filed on Feb. 4, 2011.

(51) Int. Cl. F16K 15/20

(52) U.S. Cl. CPC F16K 15/202
USPC 137/12; 137/223

(57) ABSTRACT

A valve system for use in an inflatable bladder having two opposing layers and a bladder interior disposed between the two layers, the valve system includes (i) an aperture disposed at a position on one layer for filling and deflating the bladder interior,

### FIELD OF THE INVENTION

The invention relates generally to valves and more particularly to a valve system for use in inflatable bladders such as air or fluid filled mattresses where it is desired to place a controlled pressure on the bladder.

### BACKGROUND OF THE INVENTION

There are many situations in which it is desirable to place a positive pressure on an inflatable bladder. Typical of such instances are inflatable mattresses for large animals such as cows. This is desirable because the inflatable mattress must be capable of withstanding the weight of the large animal and be comfortable for the animal. Keeping a positive pressure on the inflatable mattress may also be important to ensure that the resting surface of the mattress is easily cleanable, which helps the large animal stay healthy.

One-way valves may be used to control the pressure in an inflatable bladder. However, most of the one-way valves available in the market today are too “thick” so that a cow would easily notice it if it was stepped on. In addition, many of these one-way valves tend to restrict the flow rates into the mattress while what is desirable is to fill the mattress as fast as possible.

Another possibility may be using a hose-like or elephant trunk extending from the mattress which may be used for filling the mattress. Once the mattress has attained a desired pressure one would simply use a pinch clamp to seal off the trunk and then close the valve. The elephant trunk, however, provides a number of challenges in part due to the odd shape that it has. Once the mattress is filled and sealed, the elephant trunk is a protrusion from the normal mat shape that is in an area that is not useful. The protrusion can be rolled up, but then it becomes a large ‘bump’ that the animal can step on.

### SUMMARY OF THE INVENTION

In one embodiment, the present invention relates to a valve system for use in an inflatable bladder, the inflatable bladder comprising two opposing layers and a bladder interior disposed between the two layers, the valve system comprising (i) an aperture disposed at a position on one of the two opposing layers for filling and deflating the bladder interior, and (ii) a valve closure member placed within the interior of the bladder and configured to form a seal around a periphery of the aperture when the valve system is actuated by releasably securing together the two layers at about the position.

In accordance with another aspect of the present invention there is provided a method of inflating an inflatable bladder, said inflatable bladder comprising two opposing layers, a bladder interior disposed between the two layers, and a valve system, said valve system comprising (i) an aperture disposed at a position on one of the two opposing layers for filling or deflating the bladder interior, and (ii) a valve closure member placed within the bladder interior, said method comprising: (a) filling the bladder interior through the aperture until a desired pressure is obtained within the bladder, and (b) releasably securing the two layers at about the position of the aperture such that the valve cover member forms a seal around a periphery of the aperture thereby preventing deflation of the bladder.

### DESCRIPTION OF THE DRAWINGS

The present invention will become more fully understood from the detailed description given herein and from the accompanying drawings, which are given by way of illustration only and do not limit the intended scope of the invention.

FIG. 1 is an isometric top view of an inflatable mattress including two valve systems located in two corners of the mattress in accordance with one embodiment of the present invention.

FIG. 2 shows an isometric top view of the mattress showing a corner of the mattress cut open with a foam sheet under where the aperture of the valve system of the present invention may be located.

FIG. 3 shows a detailed isometric view of the corner of a mattress of FIG. 2. The aperture is shown on the top layer of the mattress and the foam sheet is shown with hidden lines on the bottom layer of the mattress enclosure.

FIG. 4 is an isometric view of a clamping technique in accordance to one embodiment of the present invention for sealing the aperture by pressing the port against the foam sheet.

FIG. 5 is a detailed isometric view of the clamping technique of FIG. 4.

FIG. 6 is an isometric view of the corner of a mattress in accordance to one embodiment of the present invention. The aperture is shown on the top layer of the mattress and the closure member is shown with hidden lines within the interior of the mattress around the body of the port.

FIG. 7 is a photograph of the interior of a mattress illustrating a closure member in the form of a gasket around the body of a port extending a length within the mattress interior.

In the drawings like characters of reference indicate corresponding parts in the different figures.

### DETAILED DESCRIPTION OF THE INVENTION

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise.

In one embodiment the present invention relates to a valve system for use in an inflatable bladder. The inflatable bladder may include two opposing layers, such as a first layer and a second layer, and a bladder interior disposed between the two layers. The valve system may include (i) an aperture disposed in a position on one layer for filling and deflating the bladder, and (ii) a valve closure member placed on a surface within the interior of the bladder and configured to form a seal around a periphery of the aperture when the valve system is actuated by releasably securing together the two layers at about the position.

The applicants created a new inventive way of controlling the pressure in an inflatable bladder without using a one-way valve.

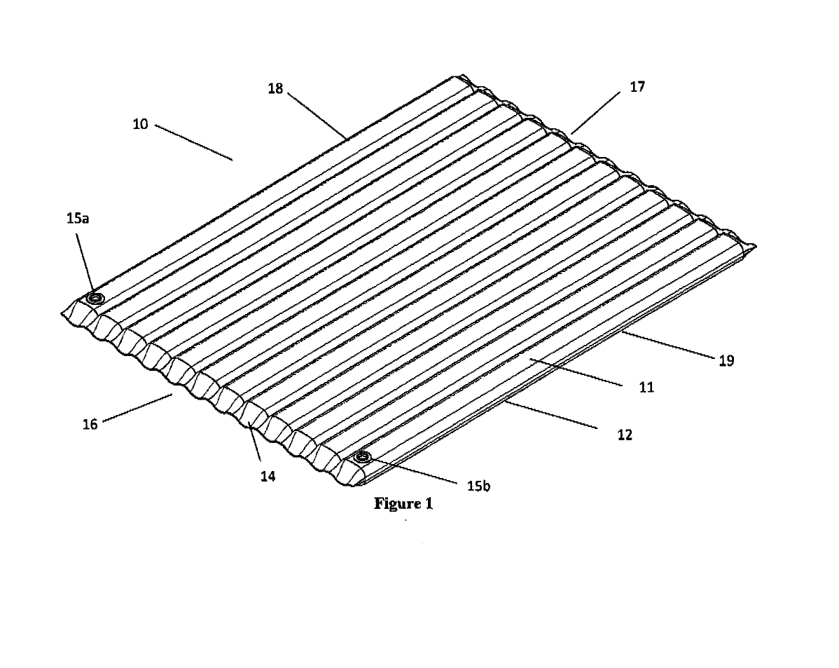

The inflatable bladder may take any suitable form. For example, the inflatable bladder may be an inflatable mattress for large animals, including cows, horses. FIG. 1 shows an inflatable animal mattress 10 in accordance with one embodiment of the present invention, which may include two pieces of an impervious materials such as PVC layers. The two pieces of material may form a first layer 11 and a second layer 12 of the inflatable animal mattress. As illustrated in FIG. 1, the first and second layers may take a substantially rectangular shape, however, it would be obvious to a person of ordinary skill in the art that other shapes may be possible. As illustrated in the embodiment of FIG. 1 the inflatable mattress 10 may comprise parallel opposing top and bottom edges 16 and 17, and parallel opposing side edges 18 and 19, with the side edges 18 and 19 being perpendicular to the top and bottom edges 16 and 17. “Inflatable”, as used in this document, means inflation with a suitable filler such as air or any other fluids, including gases, liquids and gels.

The first and second layers may form a chamber or interior of the inflatable mattress. To form the interior of the inflatable mattress, the first and second opposing layers 11, 12 may be connected at their peripheral ends throughout the periphery of the mattress 10 to form a periphery 14. It may be necessary to seal the interior to prevent the filling material from leaking out of the inflatable mattress. The first and second layers 11, 12 may, for example, be connected directly at their peripheral end by sealed end seams in order to create the sealed interior chamber of the inflatable bladder. Instead of end seams, the two layers may be joined by a plurality of threads. Alternatively, the first and second layers may be connected at their peripheral ends to side walls by for example, sealed end seams or threads (not shown in the figures).

The inflatable bladder may be manufactured in any manner and of any material(s) capable of retaining the filler under a degree of pressure necessary for its intended application.

At least one valve system of the present invention may be disposed on the inflatable mattress. The inflatable mattress of FIG. 1, for example, includes two valve systems. FIG. 1 illustrates two ports 15a and 15b on the first layer 11 in substantially close proximity to the periphery 14. One port may be used for filing the mattress with any suitable filler, while the other port may be used for deflating the mattress. It would be understood that both ports may be used for filling and deflating the mattress. Suitable fillers for inflating the bladder may include air, liquids such as water and gelatinous materials. When liquids are used to fill the mattress, one valve system may be used to fill the mattress and the second valve system may be used to release any air.

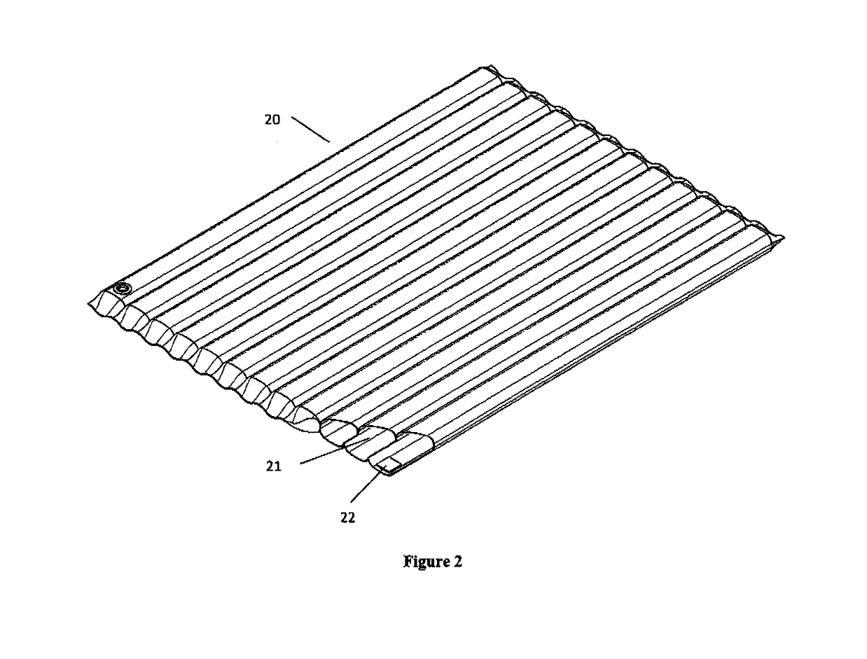

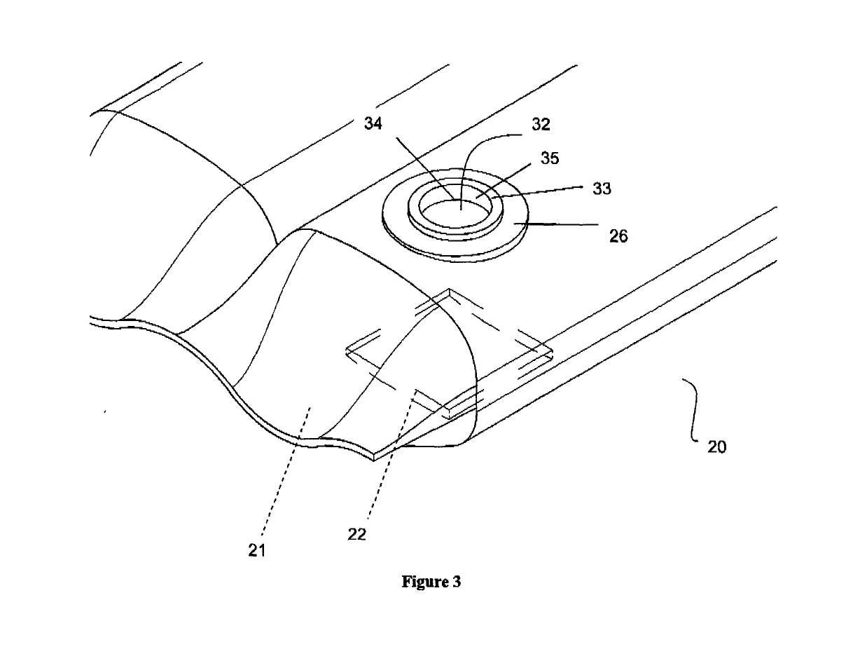

With reference to FIGS. 2 and 3, a valve system for an inflatable mattress 20 in accordance with one embodiment of the present invention is illustrated. The valve system may comprise of an aperture or outlet 32 which may be disposed at a position on one of the two layers for filling or deflating the mattress 20, and a valve closure member 22 placed within the interior 21 of the mattress 20. FIGS. 2 and 3 illustrate the valve closure member 22 placed on a surface within the interior 21 of the inflatable mattress 20.

A port 26 may be disposed within the aperture and may comprise of an elongated, hollow, tubular body, which communicates the interior of the mattress with the external atmosphere. The port 26 may take the form of a substantially tubular body having two opposing ends: a first open end, which may face the interior of the mattress 20, and a second opposing open end facing the external atmosphere. The two opposing ends may be arranged substantially co-axially on axially opposite ends of the body. The body of the port may extend a length within the bladder interior, as shown in the photograph of FIG. 7. The second end may be configured to receive a sealing cap. Within the hollow body of port 26 there may be provided threads for receiving corresponding threads of the cap, which may preferably extend substantially the entire length of the body portion. The cap and/or the port 26 may include a gasket to create an air/fluid tight seal. The aperture 32 with its associated port 26 may be disposed on the first layer or the second layer of the mattress. In one embodiment, the port may be disposed substantially proximal to the peripheral structure of the mattress. In one embodiment, the port or ports may be disposed substantially proximal to the peripheral structure and substantially near a corner of the mattress, as illustrated in the figures. Port 26 may also be configured for receiving a hose for inflating the mattress.

The valve closure member, such as a foam pad or any other suitable

membrane, may be placed within the interior of the mattress. In the embodiment shown in FIG. 3, the valve closure member 22 may be mounted at a position on the interior surface 21 of the layer that is substantially opposite to the layer in which the aperture 32 is disposed. That is, if the aperture is disposed on the first layer, then in this embodiment the valve closure member may be placed on the interior surface of the second layer of the mattress. The valve closure member may, for example, be mounted or glued to the interior surface. By being placed on the opposite layer from the aperture, when the mattress is filled through the port, the valve closure member may not impede the inflation flow rates in any way since there substantial distance from the valve closure member to the aperture. This can be distinguished from a one-way valve which would have a flapper or similar one-way mechanism that is directly in the flow stream.

The valve closure member may be made of any suitable material. For example the valve closure member may be a foam, preferably a flexible foam, or soft rubber or any other suitable material capable of forming a seal around the aperture or first opening when the valve system is actuated as described herein.

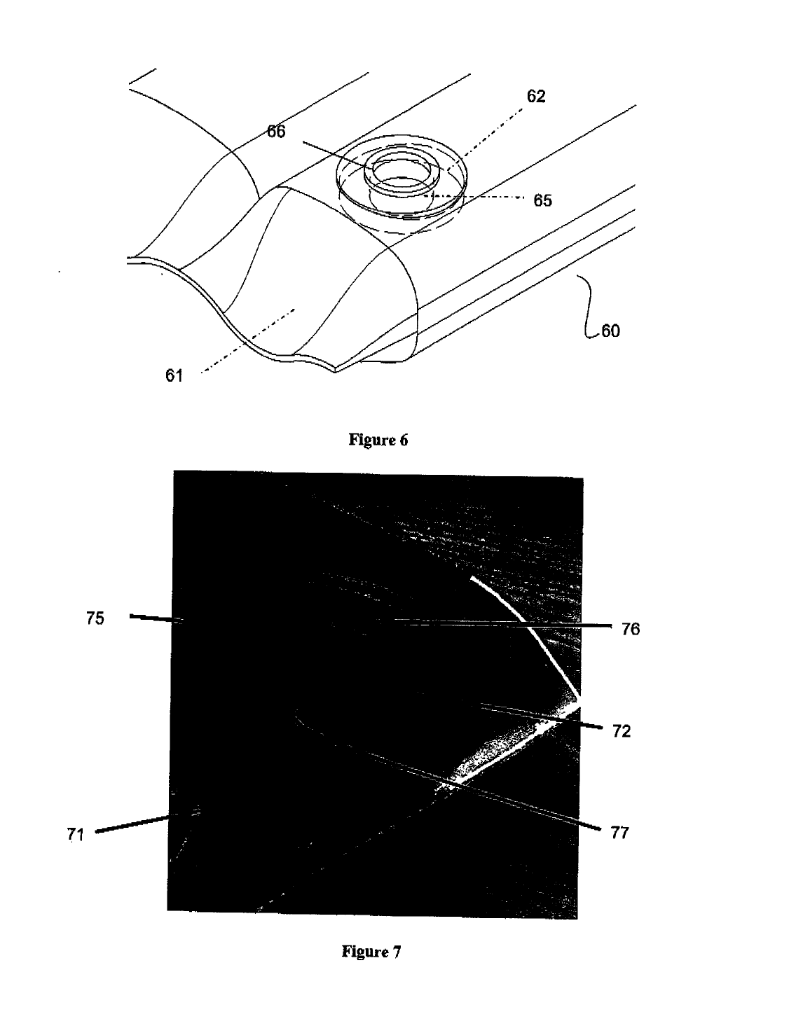

In one embodiment, illustrated in FIG. 6, the valve closure member 62 may take the form of a gasket, o-ring or donut. In this embodiment, the valve closure member 62 may be placed or mounted around the body 65 of the port 66 inside the bladder interior 61. For example, as illustrated in FIG. 7, which is a photograph of an opened mattress showing its interior 71, the valve closure member 72 in the form of a gasket or o-ring having a hole 77 may be attached to (for example glued) or fractionally accommodated around the body 75 of the port 76 that extends into the mattress interior. Since the valve closure member sits around the body of the port, the valve closure member would not impede the flow of the filler into the inflatable mattress. When the valve system is actuated by securing the two layers at about the position of the aperture, the valve closure member may abut against the interior surface of the opposite layer to the aperture and form a seal around the aperture or first opening.

In one embodiment, not shown in the figures, the valve closure member may be placed on the opposite layer from the aperture and it may take the form of a gasket, o-ring or donut having a hole or a well. The hole or well may have a size sufficient to receive the aperture or the first open end of the port if one is provided. When the valve system is actuated by securing the two layers at about the position, the valve closure member may abut against the aperture's periphery and form a seal.

In another embodiment, the valve closure member may be placed on the interior surface of the layer in which the aperture is disposed. In this embodiment, the valve closure member may include a hole or well, for example the valve closure member may take the form of a gasket, washer or o-ring. The hole or well may be of a size sufficient to receive the aperture or the first open end of the port, such that the valve closure member surrounds the aperture or the first open end. Since the aperture may sit within the hole or well, the valve closure member would not impede the flow of the filler into the inflatable mattress. Then when the mattress attains a desired pressure, the first layer may be releasably secured to the second layer at about the position of the first open end such that the valve closure member abuts against the second layer and may provide a seal around a periphery of the aperture for preventing deflation of the inflatable mattress.

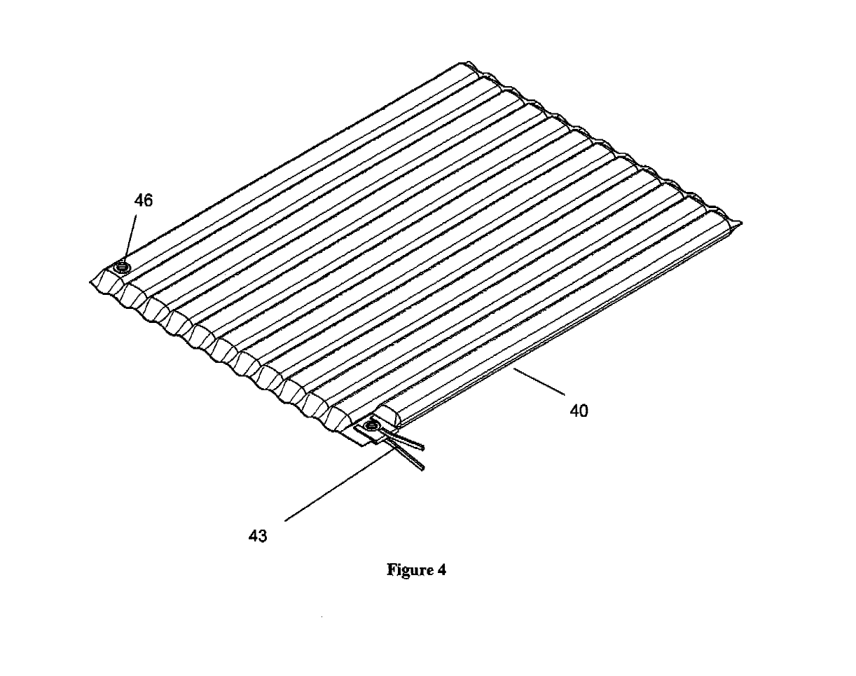

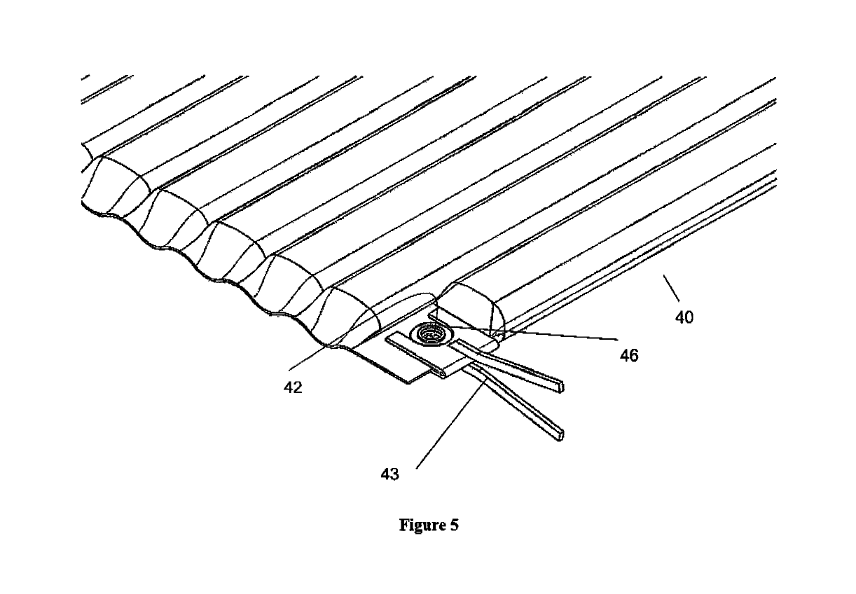

With reference to FIGS. 4 and 5, in operation, a hose or any other filling device may be connected to the port 46 to fill the bladder. Once the bladder 40 attained a desired pressure, clamping means, such as the clamps 43 shown in FIGS. 4 and 5, may be used to releasably secure the first and the second layer at about the position of the aperture such that the valve closure member 42 (shown in grey in FIG. 5) may abut against a periphery of the aperture and may form a seal about or around the first open end of the port 46, thereby preventing the bladder from deflating. The hose may then be safely removed without worry on losing pressure within the bladder. A cap or lid may then be used to close and seal the port. The clamping means may then be removed, thereby leaving the bladder filled at the desired pressure.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

What is claimed:

1. A inflatable bladder valve system, the inflatable bladder comprising two opposing layers and a bladder interior disposed between the two layers, the inflatable bladder valve system comprising (i) an aperture disposed at a position on one of the two opposing layers for filling and deflating the bladder interior, and (ii) a valve closure member placed within the interior of the bladder and configured to form a seal around a periphery of the aperture when the valve system is actuated by releasably securing together the two layers at about the position.

2. The inflatable bladder valve system of claim 1, wherein said valve closure member is placed on the surface of the other layer within the interior of the bladder.

3. The inflatable bladder valve system of claim 2, wherein said valve closure member includes a hole or well configured to receive the aperture when the valve system is actuated.

4. The inflatable bladder valve system of claim 1, wherein said valve closure member is in the form of a gasket placed around the periphery of the aperture.

5. The inflatable bladder valve system of claim 1, wherein said valve closure member is placed on the interior surface of the other layer, and wherein said valve closure member is configured to abut against the periphery of the aperture when the valve system is actuated by releasably securing together the two layers at about the position.

6. The inflatable bladder valve system of claim 1, wherein said aperture comprises a port having a hollow body, said hollow body having a first open end facing the bladder interior, and a second open end facing an exterior of the bladder.

7. The inflatable bladder valve system of claim 1, wherein the valve closure member is a foam pad.

8. The inflatable bladder valve system as in any one of claims 1 to 7, wherein said inflatable bladder is an inflatable animal mattress.

9. A method of inflating an inflatable bladder, said inflatable bladder comprising two opposing layers and a bladder interior disposed between the two layers, and a valve system, said valve system comprising (i) an aperture disposed at a position on one of the two layers for filling or deflating the bladder interior, and (ii) a valve closure member placed within the interior of the bladder, said method comprising: (a) filling the bladder interior through the aperture until a desired pressure is obtained within the bladder, and (b) releasably securing the two layers at about the position of the aperture such that the valve closure member forms a seal around a periphery of the aperture thereby preventing deflation of the bladder.

10. The method of claim 9, wherein said method further comprises closing the aperture with a cap or lid, and releasing the two layers.

11. The method of claim 9, wherein said valve closure member is placed on the interior surface of the other layer.

12. The method of claim 11, wherein said valve closure member includes a hole or well configured to receive the aperture when the valve system is actuated.

13. The method of claim 9, wherein said valve closure member is in the form of a gasket placed around the periphery of the aperture.

14. The method of claim 9, wherein said valve closure member is placed on the interior surface of the other layer, and wherein the valve closure member is configured to abut against the periphery of the aperture when the valve system is actuated by releasably securing together the two layers at about the position.

15. The method of claim 9, wherein said aperture comprises a port having a hollow body, said hollow body having a first open end facing the bladder interior, and a second open end facing an exterior of the bladder.

16. The method of claim 9, wherein the valve closure member is a foam pad.

17. The method as in any one of claims 9 to 16, wherein said inflatable bladder is an inflatable animal mattress.

18. The inflatable bladder valve system of claim 2, wherein said valve closure member is in the form of a gasket placed around the periphery of the aperture.

19. The inflatable bladder valve system of claim 3, wherein said valve closure member is in the form of a gasket placed around the periphery of the aperture.

20. The inflatable bladder valve system of claim 3, wherein the valve closure member is a foam pad.
